(19) United States
(12) Patent Application Publication
(10) Pub. No.: US 2006/0126525 A1
(43) Pub. Date: Jun. 15, 2006

(54) Telecommunication system statistical counting method

(76) Inventor: Sheng-Chih Chan, Feng-Yuan City (TW)

Correspondence Address: CHARLES E. BAXLEY, ESQ., 90 JOHN STREET, THIRD FLOOR, NEW YORK, NY, 10038, US

(21) Appl. No.: 10/995,590

(22) Filed: Nov. 22, 2004

(51) Int. Cl. H04J 1/16; H04Q 11/00; H04L 12/26

(52) U.S. Cl. 370/252; 370/261

(57) ABSTRACT

The present invention relates to a telecommunication system automatic statistical counting method, in which the host sends out the invitation letter, applying to the telecommunication company for reserved number paid by the host as so to allow the guest end to make a dial or use computer network for free. The host end is saved with all the guest's basic information which are inputted by optical character recognition scanning, typing, and etc., providing identity check to incoming caller and person access by internet. The host end is preset with an identity confirmation procedure, and a voice system or computer network message for guiding guest end login.

### BACKGROUND OF THE INVENTION

1. Field of the Invention

The present invention relates to a telecommunication system statistical counting method, and more particularly to a method of high statistical efficiency and accuracy in counting by fully automatic operation procedure.

2. Description of the Prior Arts

Counting up the number of people present at the meeting or the wedding is really a hard work for the host. Because the number of guest or participant concerns the space for activities, decoration, and time and money spend on it, especially for the large wedding banquet or meeting, since the number of participant is great and if it is not counted accurately, more tables and seats have to be reserved, and this will lead to unnecessary meal expense and extra cost.

Therefore, confirmation column is added on the letter of invitation for letting the invitee confirm whether to participate and the number of participants attending by sending the invitation letter back to the host or just by calling. However, habitual method is by mail, and it is time-consuming that the invitees have to go to post office to send the reply, for this reason or for fear of hurting the host's feelings, most of the invitees will not reply to the host if they are going to come, thus easily causing errors in the statistic.

This shows the habitual methods still has many deficiencies; it is not a very good design and requires improvement.

To overcome the problems derived from the aforementioned conventional statistical counting method, the inventor of this prevention has successfully developed a method for counting number of people automatically by using telecommunication system.

### SUMMARY OF THE INVENTION

The primary objective of the present invention is to provide a telecommunication system automatic statistical counting method capable of counting number of people automatically by using telecommunication system or telephone network, thus improving statistical efficiency and accuracy.

The secondary objective of the present invention is to provide a telecommunication system automatic statistical counting method capable of ensuring all the invitations are confirmed by the invitees through active and passive means, thus improving the statistical count accuracy.

The third objective of the present invention is to provide a telecommunication system automatic statistical counting method capable of substantially reducing the cost of food and drink prepared for a wedding, meeting or the like events, and ensuring effective control over the time and location.

A telecommunication system automatic statistical counting method is provided accordance with the present invention including: the host sends out the invitation letter, applying to the telecommunication Company for reserved number or using computer network, and sets up guest information and statistical counting procedure at the host end database. After received the invitation letter, the guest end could connect to the host end via the reserved number or computer network, and proceed with the login procedure to enable statistical counting to be proceeded at the host end. A few days before the invitation time, the computer will count the number of unregistered guests, and automatically call them to make a confirmation for ensuing a correct statistical result.

The present invention will become more obvious from the following description when taken in connection with the accompanying drawings, which show, for purpose of illustrations only, the preferred embodiments in accordance with the present invention.

### BRIEF DESCRIPTION OF THE DRAWING

FIG. 1 is a flow chart for showing a telecommunication system automatic statistical counting method in accordance with the present invention.

### DETAILED DESCRIPTION OF THE PREFERRED EMBODIMENTS

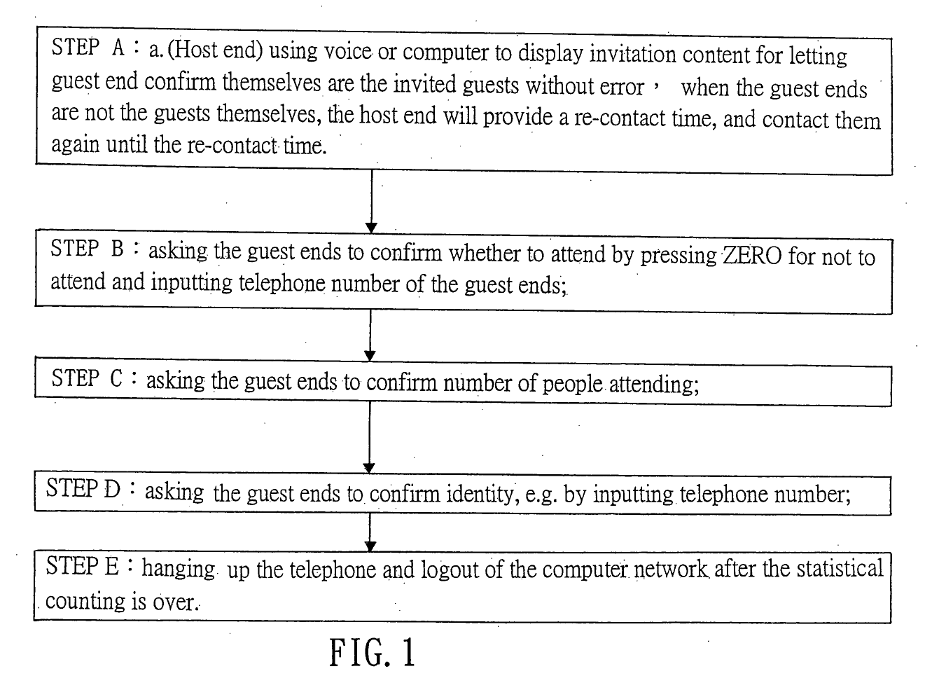

Referring to FIG. 1, which shows a telecommunication system automatic statistical counting method, in which the host sends out the invitation letter, applying to the telecommunication company for reserved number paid by the host as so to allow the guest end to make a dial or use computer network for free. The host end is saved with all the guest's basic information which are inputted by optical character recognition scanning, typing, and etc., providing identity check to incoming caller and person access by internet. The host end is preset with an identity confirmation procedure, and a voice system or computer network message for guiding guest end login.

Upon receipt of the invitation letter, the guests will dial the toll free phone number or logon the computer network as listed on the invitation letter, then the host end will use voice message or computer network to guide the guests to login telecommunication system for automatic counting. The detail steps for this method are explained as follows:

a. (Host end) using voice or computer to display invitation content for letting guest end confirm themselves are the invited guests without error;

b. asking the guests to confirm whether to attend by pressing 0 (preset number) for not to attend;

c. asking the guest end to confirm the number of people attending;

d. asking the guest end to confirm identity, e.g. by inputting telephone number;

e. hanging up the telephone or logout of the internet after statistical counting is over.

After the above steps, the host end then inputs the number of attendance into the database to proceed with follow-up statistical work.

The design for the above steps should be simple and clear, but for a more larger and complicated wedding banquet or conference, more confirmation steps should be added as required to the increase the accuracy. For example:

1. adding a multi-lingual system, including German, Japanese or French, English etc, so the guest end can select appropriate language to proceed with login., or, after a few seconds without inputting action or hanging up telephone, multi-lingual system will automatically change to another language to avoid guest end not understanding the prompt phrase.

2. providing confirmation procedure, so after guest end input attending guest number, the host end will automatically read out the content of input for guest end to confirm;

3. providing instant correction procedure, namely, confirmation requested after each input, and input again if there are any errors;

4. providing post correction procedure, if guest end changes schedule, cancellation or alteration on number of attending guest is possible by telephone or internet;

5. providing safety system by designing a more complex confirmation procedure to avoid children or unrelated person from inputting by mistake.

Further, to avoid participants from forgetting to register, this invention design includes an automatic confirmation system, that is, a few days before the party, the computer system database registry personnel will list out those not yet registered, and then telecommunication system will automatically call the guests to make a confirmation according to the following steps after the guest end is connected:

a. the host end display the invitation content and read the name of guest, so as to let guest end confirm;

b. If the guest end is not the guest themselves or unable to make impromptu decision, the host end will provide a re-contact time, and contact them again until the re-contact time.

c. asking the guests to confirm whether to attend by pressing 0 (preset number) for not to come;

What is claimed is:

1. A telecommunication system automatic statistical counting method set up on a telecommunication system and a computer network, comprising a host end connected to a plurality of guest ends, and including the following steps (to be operated by the host end):
using voice and computer to display invitation content for letting the guest ends confirm themselves are the invited guests without error;
asking the guest ends to confirm whether to attend by pressing a preset number for not to attend and inputting telephone number of the guest ends;
asking the guest ends to confirm number of people attending;
asking the guest ends to confirm identity, e.g. by inputting telephone number;
hanging up the telephone and logout of the computer network after the statistical counting is over.

2. The telecommunication system automatic statistical counting method as claimed in claim 1, wherein the host end provides a toll-free phone number to allow the guest ends to connect 4the host end to register by using telephone and computer network for free.

3. The telecommunication system automatic statistical counting method as claimed in claim 1, wherein a computer at the host end will count the number of unregistered guests, a few days before invitation time, and automatically call the unregistered guests to ask them to confirm their identity and number of attending.

4. The telecommunication system automatic statistical counting method as claimed in claim 1, wherein the host end is saved with all guest's information which are inputted by optical character recognition scanning, typing, and etc., providing identity check to incoming caller and person accessed by internet.

5. The telecommunication system automatic statistical counting method as claimed in claim 1, wherein the host end is provided with a multi-lingual system, so that the guest ends can select appropriate language to proceed with login, in case that the guest ends don′ input number and hang up in a predetermined length of time, the multi-lingual system will automatically change to another language.

6. The telecommunication system automatic statistical counting method as claimed in claim 1, after the guest ends input a set of number, the host end will automatically read out the content of input for the guest ends to confirm;

7. The telecommunication system automatic statistical counting method as claimed in claim 1, wherein a confirmation is requested after each number is input, and the guest ends need to input again if the inputted number is wrong;

8. The telecommunication system automatic statistical counting method as claimed in claim 1, wherein the guest ends can cancel their confirmation and change the number of attending via telephone and internet;

9. The telecommunication system automatic statistical counting method as claimed in claim 1, wherein the host end is provided with a confirmation procedure which is used to avoid children and unrelated person from inputting by mistake.

10. The telecommunication system automatic statistical counting method as claimed in claim 1, when the guest ends are not the guests themselves, the host end will provide a re-contact time, and contact them again until the re-contact time.
